(19) United States
(12) Patent Application Publication
(10) Pub. No.: US 2023/0415091 A1
(43) Pub. Date: Dec. 28, 2023

(54) Adsorption Device for Adsorbing CO2, Elemental Analyzer and Method for Removing CO2 From a Fluid Stream

(71) Applicant: C. Gerhardt GmbH & Co. KG, Königswinter (DE)

(72) Inventors: Uwe Jeub, Königswinter (DE); Tatjana Adamek, Königswinter (DE); Nadine Nülle, Königswinter (DE)

(21) Appl. No.: 18/214,045

(22) Filed: Jun. 26, 2023

(30) Foreign Application Priority Data
Jun. 27, 2022 (EP) 22181260.5

(51) Int. Cl. B01D 53/04; G01N 31/12

(52) U.S. Cl. CPC B01D 53/0438; B01D 53/0431; B01D 53/0446; G01N 31/12; B01D 2257/504; B01D 2259/4009

(57) ABSTRACT

An adsorption device for adsorption of CO₂ for an elemental analyzer includes a filter having an inlet for a fluid, an outlet for the fluid, and an adsorbent material through which the fluid can flow, and a heating device for heating the adsorbent material. The adsorption device is characterized in that the heating device extends along a longitudinal axis and the filter is arranged coaxially with the longitudinal axis and at least partially radially surrounds the heating device. In addition, an elemental analyzer includes a combustion reactor for burning a sample, an optional reduction reactor, an optional water separator, and a detector. The elemental analyzer further includes the adsorption device for adsorbing CO₂ and a valve control for alternately passing an analysis fluid from the combustion reactor through the adsorption device for adsorbing CO₂ and to the detector, or a flushing fluid through the adsorption device for adsorbing CO₂.

### CROSS-REFERENCE TO RELATED APPLICATION

This application claims priority to European Patent Application No. 22181260.5 filed Jun. 27, 2022, the disclosure of which is hereby incorporated by reference in their entirety.

### BACKGROUND

### Field

The present disclosure relates to an adsorption device for adsorbing CO₂, an elemental analyzer comprising the adsorption device, and a method for removing CO₂ from a fluid stream, in particular a gas stream.

### Description of Related Art

The present disclosure relates to the field of elemental analyzers. Elemental analyzers are used to determine the content of certain chemical elements in a sample. Such devices are used, for example, to determine the nitrogen content in organic samples, in particular in food samples. The nitrogen content can be used, for example, to draw conclusions about the protein content of a food sample.

In the elemental analysis of organic samples, the organic samples are first broken down into their elemental gas components by combustion. This produces combustion gases which, depending on the sample, have different compositions of gas substance combinations. The main gases are COₓ, water vapor, elemental nitrogen and nitrogen oxides. In order to break down the COₓ and NOₓ combinations and allow them to react to form more easily manageable combinations, the combustion gas (also called sample gas) is first passed through a catalyst and then, in a second step, usually through a reduction reactor. Subsequently, water is usually removed from the sample gas stream by means of one or more water traps. In a further step, CO₂ is removed from the sample gas stream by means of an adsorption device for adsorbing CO₂. The sample gas stream thus obtained contains essentially only elemental nitrogen, the concentration of which in the sample gas stream can be determined in a final step by means of a detector, usually by means of a thermal conductivity detector.

The known adsorption devices contain an adsorbent material that binds CO₂ from the sample gas stream. For example, natural and synthetic zeolites, also known as molecular sieves, are used as adsorbent material. CO₂ is bound on the surface of the adsorbent material at room temperature. Once the adsorbent material is fully loaded with CO₂, it must first be regenerated before further use. Regeneration is accomplished by heating the adsorbent material, preferably to temperatures above 220° C. At elevated temperature, the adsorbent material releases the bound CO₂. For complete removal of the CO₂, a stream of purge gas is also passed through the adsorbent material. After regeneration, the adsorbent material is cooled down and can be reloaded.

The patent specification EP 2 013 615 B1 discloses an adsorption device for adsorbing CO₂ with a filter comprising an adsorbing material and a heating device for heating the adsorbing material. The filter is formed by a U-shaped tube, inside of which the adsorbent material is arranged. The heating device consists of a heating wire spirally wound around the outside of the U-shaped tube. Thus, the adsorbent material can be heated from the outside by means of the heating device for regeneration. The adsorption device additionally comprises a valve device by means of which a sample gas flow and a purge gas flow can be alternately passed through the filter, the purge gas flow being passed through the filter in the opposite direction to the sample gas flow.

### SUMMARY

It is the aim of the present disclosure to provide an improved adsorption device for the adsorption of CO₂, with which in particular the regeneration of the adsorbing material can take place more effectively and efficiently. This means that bound CO₂ can be flushed out of the adsorbing material as completely as possible and with a minimum expenditure of energy and time. In addition, the adsorption device should enable complete adsorption of CO₂ from a sample gas stream. Finally, the adsorption device should be simple and inexpensive to manufacture and maintain.

To solve this problem, the present disclosure an adsorption device for adsorbing CO₂ for an elemental analyzer, an elemental analyzer, and a method for removing CO₂ from a fluid stream.

Adsorption Device

The adsorption device for adsorption of CO₂ for an elemental analyzer according to the disclosure comprises a filter having an inlet for a fluid, an outlet for the fluid, and an adsorbent material through which the fluid can flow, and a heating device for heating the adsorbent material. The adsorption device is characterized in that the heating device extends along a longitudinal axis and the filter is arranged coaxially with the longitudinal axis and at least partially radially surrounds the heating device.

As a result of the fact that the filter, and thus also the adsorbent material present in the filter, at least partially radially enclose the heating device, the heat given off radially to the outside by the heating device, and thus the heating power, is better utilized. This distinguishes the adsorption device according to the disclosure from the adsorption device disclosed in EP 2 013 615 B1, in which the heating device is arranged on the radial outside of the filter, so that the radially outwardly emitted heat cannot be used to heat the adsorbent material.

The adsorption device according to the disclosure also achieves a highly homogeneous heat distribution within the adsorbing material. This improves the regeneration performance. The regeneration of the adsorbing material takes place quickly and completely in the adsorption device according to the disclosure.

The design of the adsorption device according to the disclosure also facilitates the assembly and maintenance of the heating device and the filter. For example, the heating device can be inserted into a corresponding axial receptacle of the filter and separated from the filter again in this way. In the adsorption device according to EP 2 013 615 B1, on the other hand, the heating device consists of a heating wire wound spirally around a U-shaped tube, so that the heating device can only be separated from the filter with great effort.

The terms “inlet” and “outlet” are used to describe the openings of the filter through which the fluid can flow into and out of the filter, respectively. In the context of the present description, unless expressly stated, these terms are not intended to imply any restriction with respect to the direction of flow. Thus, it is also possible, during operation of the adsorption device, to direct the fluid from the opening designated as the “outlet” to the opening designated as the “inlet” and vice versa.

The filter at least partially encloses the heater in a radial direction, the radial direction being defined with respect to the longitudinal axis. It is not essential that the filter completely covers the radial surface of the heater, but it is also possible for the filter to leave gaps in which, for example, air can circulate between the radial outside of the filter and the radial surface of the heater.

The filter can partially or completely enclose the heating device in the radial direction. Preferably, the filter covers an angular range of at least 45° in a projection plane perpendicular to the longitudinal axis, more preferably at least 90°, further preferably at least 180°. Here, a projection plane is considered, that is, the cross-section of the filter is projected onto a plane perpendicular to the longitudinal axis to determine the degree of radial enclosure. Most preferably, the filter covers an angular range of 360°, that is, it completely encloses the heater.

The heating device preferably extends along a straight longitudinal axis and is, for example, rod-shaped. In this case, the straight longitudinal axis is also the longitudinal axis of the heating device. This embodiment has the advantage that a rod-shaped longitudinal axis can be easily inserted into a corresponding receptacle in the filter and pulled out again.

In one embodiment, the filter forms a receptacle extending along the longitudinal axis, wherein the heating device extends along a straight longitudinal axis and is configured to be removable insertable into the receptacle.

However, it is also possible for the heating device to have the shape of a curved rod. For example, the heater may be U-shaped. Such a curved rod has a curved longitudinal axis. In this case, the longitudinal axis along which the heater extends is curved and the shape of the filter follows the curvature of the longitudinal axis.

In one embodiment, the filter is arranged spirally around the heating device along the longitudinal direction. The spiral-shaped filter encloses an axial cavity in which the heating device is arranged. In this embodiment, the filter completely surrounds the heating device in the radial direction. In this embodiment, there are gaps between the turns of the spiral-shaped filter through which air can circulate between the radial outside of the filter and the surface of the heating device. This makes it possible to increase the surface area of the filter available for heat exchange in proportion to the amount of adsorbent material used. This favors the absorption of the thermal heat emitted by the heating device and allows a homogeneous temperature distribution within the adsorbent material. In addition, this embodiment allows faster cooling of the adsorbent material after regeneration has taken place.

In this embodiment, the filter is preferably in the form of a spiral tube, at the ends of which the inlet and the outlet are arranged. Preferably, the inlet and the outlet are thus arranged at opposite ends of the filter with respect to the longitudinal axis.

The tube represents a container for holding the adsorbent material. The tube can be made of glass, stainless steel or plastic, for example, with glass being the most preferred material. In the case of plastic, care should be taken to select a heat-resistant material or to lower the temperature accordingly for regeneration of the adsorbent material. The spiral tube is filled with the adsorbent material to the extent that the material can be heated by the heater, although it is not necessary to fill the tube completely with the adsorbent material. In the case of a curved heater, for example a heater in the form of a U-shaped rod, the spiral-shaped filter is also curved and follows the curvature of the heater.

The diameter of the tube is preferably 5 mm to 50 mm, particularly preferably 6 mm to 15 mm. With this diameter, optimum heat distribution is achieved within the adsorbent material.

Preferably, the heating device in this embodiment is rod-shaped so that the longitudinal axis is a straight line. In this way, it is possible to insert the heating device into the axial cavity of the spiral-shaped filter. This facilitates the assembly of the entire adsorption device. The adsorption device can be easily disassembled in a corresponding manner, in which the heating device is simply pulled out of the spiral-shaped filter. This facilitates the maintenance of the entire adsorption device.

In another embodiment, the filter comprises a first chamber, wherein the adsorbent material is disposed within the first chamber. In this embodiment, the first chamber surrounds a cavity extending along the longitudinal axis. The heating device is disposed within the cavity. In this embodiment, the filter completely surrounds the heating device in the radial direction.

In this embodiment, it is possible but not mandatory that the filter fully covers the radial surface of the heating device. This means that the filter leaves no gaps through which air can circulate in the radial direction. The thermal heat radiated in the radial direction is thus almost completely absorbed by the filter and is thus available for heating the adsorbing material. In this way, the energy efficiency of the adsorption device can be increased.

In one variant of this embodiment, the filter has only the first chamber in which the adsorbent material is arranged. This chamber preferably extends along the longitudinal axis. The chamber surrounds the axial cavity in which the heating device is arranged. Preferably, in this variant, the inlet and the outlet are arranged at opposite ends of the chamber with respect to the longitudinal axis, so that the fluid can flow through the adsorbent material in one direction.

In a further variant, the filter has, in addition to the first chamber, a second chamber which is fluidically connected to the first chamber. The second chamber surrounds the axial cavity in which the heating device is arranged and is arranged in radial direction between the first chamber and the cavity. Preferably, both the first and second chambers are thus arranged coaxially with respect to the longitudinal axis and both surround the axial cavity, the second chamber being arranged radially inwardly and the first chamber being arranged radially outwardly.

In this embodiment, the adsorbent material may be disposed in either the outer, first chamber or the inner, second chamber or both chambers. In a preferred embodiment, the adsorbent material is disposed only in the outer, first chamber.

In this embodiment, the inlet is connected to one of the two chambers and the outlet is connected to the other of the two chambers. For example, the inlet is connected to the outer, first chamber and the outlet is connected to the inner, second chamber, or the inlet is connected to the inner, second chamber and the outlet is connected to the outer, first chamber. In this case, the inlet and outlet are preferably located at the same end of the filter with respect to the longitudinal axis. The fluidic connection between the first and second chambers is preferably at the opposite end of the filter with respect to the longitudinal axis. Thus, it is possible for the fluid flow to first flow through one chamber in one direction and then flow through the other chamber in the opposite direction.

In a preferred embodiment, the adsorbent material is arranged only in the outer, first chamber, and the inlet and outlet of the filter are arranged so that the fluid stream first flows through the inner, second chamber and only then flows through the outer, first chamber. In this manner, the fluid flow is first heated by the heating device in the inner, second chamber, which is closer to the heating device. Subsequently, the heated fluid stream flows through the outer, first chamber, heating the adsorbent material. Thus, a homogeneous temperature distribution is created in the adsorbent material with the help of the fluid flow.

In a preferred embodiment of all filter variants, the adsorption device additionally comprises a cooling device for cooling the adsorbing material. With the aid of the cooling device, it is possible to cool the adsorbent material back down to the temperature required for adsorption of CO₂ within a short time after regeneration has taken place and thus make it ready for operation.

The cooling device is preferably a fan. The fan blows air in the direction of the filter so that the adsorbent material in the filter is cooled. The air used for cooling is preferably at room temperature. However, the fan may also be equipped with an additional cooling unit, for example a water cooling unit, and a heat exchanger so that the air used for cooling can be cooled to temperatures below room temperature. Preferably, the fan and the filter are arranged so that the air is directed onto the filter in a radial direction with respect to the longitudinal axis.

The use of a fan is particularly preferred in combination with the spiral filter described above, as the air used for cooling can circulate between the turns of the spiral filter. This improves the heat exchange between the air used for cooling and the filter and provides faster cooling of the adsorbent material. This effect is particularly pronounced when the air used for cooling is directed onto the filter in a radial direction.

Preferably, the air used for cooling is directed from the fan through a flow channel onto the filter. The flow channel does not necessarily have to run in a straight line, but can be designed in such a way that the air used for cooling is guided around one or more corners. For example, it is possible to arrange the fan in an axial direction above or below the filter so that the air used for cooling first exits the fan in a direction parallel to the longitudinal axis. Subsequently, the air used for cooling is deflected through the flow channel and hits the filter from a radial direction.

The flow channel is preferably formed by a housing which at least partially encloses the filter and the heating device. The cooling device can also be at least partially enclosed by the housing or arranged outside the housing. Preferably, the housing comprises a plurality of internal lamellar walls through which one or more flow channels are formed.

The heating device for heating the adsorbent material is preferably an electric heating device. The use of an electric heating device has the advantage that it can be heated up and cooled down quickly. This enables shorter cycle times in the regeneration of the adsorbent material.

In one embodiment, the heating device is formed by an electric heating wire arranged spirally around a rod-shaped base. A spiral-shaped heating wire enables a uniform delivery of the heating heat to the adsorbent material.

As mentioned above, the heater may be rod-shaped so that the longitudinal axis is either a straight line, or the heater may be in the form of a curved rod so that the longitudinal axis is also curved. Accordingly, the rod-shaped base may be straight or have a curved shape. In the case of a curved rod-shaped base, the spiral of the heating wire also follows the curvature of the rod-shaped base. However, the use of a straight rod-shaped base is preferred.

The rod-shaped base is preferably formed from an electrically non-conductive material. It is also possible that the rod-shaped base has at least one electrically non-conductive surface. The rod-shaped base is preferably tubular and is particularly preferably formed by a mica tube.

The use of a tubular, rod-shaped base has the advantage that further functional elements can be arranged within the rod-shaped base. In a preferred embodiment, a temperature sensor is arranged within the rod-shaped base, which is used to control the heating device.

In a preferred embodiment, the adsorption device comprises a first valve unit connected to the inlet. By means of this unit, a first and a second fluid can be alternately fed into the filter. Preferably, the valve unit comprises at least two valves. This makes it possible to feed an analysis fluid into the filter via one valve and a flushing fluid via another valve.

In a further embodiment, the adsorption device additionally has a second valve unit which is connected to the outlet and by means of which the fluid from the filter can be passed alternately to different consumers. This makes it possible, for example, to route the fluid from the filter alternately to a downstream detector or to a further outlet.

By means of the first and second valve units, it is possible to alternately pass an analysis fluid through the filter, which is then passed to a downstream detector, or to pass a flushing fluid through the filter, which is then passed to a further outlet. Optionally, it is also possible to pass the flushing fluid to the detector as well, for example to determine the amount of bound CO₂.

It is not necessary for the analysis fluid and the flushing fluid to flow through the filter in the same direction. It is also possible for the flushing fluid to be directed through the filter in the opposite direction to the analysis fluid. In this case, the flushing fluid may be directed into the filter via the outlet of the adsorption device and directed out of the filter via the inlet of the adsorption device, while the analysis fluid is directed into the filter via the inlet of the adsorption device and further directed to the detector via the outlet of the adsorption device. However, it is equally possible for both the analysis fluid and the flushing fluid to be introduced into the adsorption device via the inlet and discharged from the adsorption device via the outlet, thus passing through the filter in the same direction.

In a further embodiment, the inlet and the outlet of the filter each have a connection element with which the inlet and the outlet can each be connected in a fluid-tight manner to a valve or a valve unit. In this embodiment, the respective valves or valve units are not themselves part of the adsorption device. Preferably, the two connecting elements allow a detachable connection to the respective valves or valve units. In this way, it is possible to connect the adsorption device in a simple manner to a valve unit provided outside the adsorption device. The adsorption device can thus be manufactured in the form of a module which can be easily integrated into an existing elemental analyzer.

Any material that can adsorb CO₂ from the fluid stream can be used as adsorbent material. Preferably, a molecular sieve is used as adsorbent material. Particularly preferably, the adsorbing material consists of natural or synthetic zeolites. To improve the adsorption properties, the adsorbing material may also be coated. Preferably, the adsorbent material is in the form of granules. The average particle size of the granules is preferably chosen to be as small as possible to maximize the specific surface area of the adsorbent material. However, a grain size that is too small has a negative influence on the service life of the adsorbent material. Preferably, the particle size of the adsorbent material is in the range of 1 mm to 3 mm. Preferably, the measured size of the zeolite structure is in the range of 8 μm to 15 μm. In this particle size range, a particularly advantageous ratio of adsorption capacity to service life is achieved.

In addition to the adsorbent material for adsorbing CO₂, the filter can comprise further adsorbent materials, in particular for adsorbing water and sulfur-containing compounds, in particular SO₂. These are preferably arranged upstream with respect to the direction of flow of the analysis fluid from the adsorbing material for adsorption of CO₂. By means of these additional adsorbing materials, impurities can be removed from the analysis fluid that would otherwise lead to damage of the adsorbing material for adsorption of CO₂. For example, silica gel or aluminum oxide can be used to adsorb water. For adsorption of sulfur-containing compounds, in particular SO₂, silica gel or activated carbon can be used, for example.

The adsorption device is preferably intended for use in an elemental analyzer, preferably for use in an elemental analyzer for analyzing organic samples, most preferably for use in an elemental analyzer for analyzing food samples, most preferably for use in an elemental analyzer for determining the nitrogen content in a food sample. However, the adsorption device is also suitable for any other application where CO₂ needs to be removed from a fluid.

The adsorption device is designed for adsorption of CO₂ from any fluid. The fluid may contain liquid and gaseous components. In addition, the fluid may also contain solid particles, for example soot particles, as long as the particle size and amount of solid particles do not lead to an impairment of the adsorbing material. Preferably, the fluid is a gas or a gaseous mixture, particularly preferably a gaseous mixture that may contain water vapor. Particularly preferably, the fluid comprises only gaseous components.

Elemental Analyzer

The elemental analyzer according to the disclosure comprises a combustion reactor for burning a sample, an optional reduction reactor, an optional water separator, and a detector. The elemental analyzer is characterized in that it comprises the adsorption device described above for adsorbing CO₂ and a valve control for alternately directing an analysis fluid from the combustion reactor through the adsorption device and to the detector or a flushing fluid through the adsorption device.

In a preferred embodiment, the elemental analyzer is a device for analyzing organic samples, in particular food samples. The food sample may be, for example, food for human consumption or feed for animal consumption. Preferably, the elemental analyzer is used to determine the nitrogen content in a sample. Particularly preferably, it is an analyzer for determining the nitrogen content in a food sample.

The reduction reactor is preferably arranged downstream of the combustion reactor and upstream of the adsorption device. Preferably, a copper reactor is used as the reduction reactor, with copper serving as the catalyst for the reduction reaction. Optionally, another catalyst can also be used, which is arranged in or upstream of the reduction reactor. By means of the reduction reactor, the nitrogen oxides present in the analysis fluid, which may be formed in the combustion reactor, are reduced to elemental nitrogen.

The optional water separator is arranged downstream of the combustion reactor and preferably downstream of the reduction reactor, if present. The water separator is arranged upstream of the adsorption device. The water separator is used to remove any water present in the analysis fluid from the analysis fluid.

The elemental analyzer comprises at least one adsorption device described above. Preferably, the elemental analyzer comprises two or more adsorption devices, more preferably two to twelve adsorption devices, most preferably four to eight adsorption devices. In a particularly preferred embodiment, the elemental analyzer comprises six adsorption devices. With a plurality of adsorption devices, it is possible to shorten the cycle time of the elemental analyzer. For example, a first sample can first be combusted and the resulting analysis fluid can be passed through the first adsorption device. Subsequently, a second sample may be combusted and the resulting analysis fluid passed through a second adsorption device while the first adsorption device is regenerated.

The elemental analyzer includes a valve control that can alternately direct the analysis fluid formed in the combustion reactor and a flushing fluid through the adsorption device. Preferably, the valve control can alternate between a plurality of operating states. For example, in a first operating state, the valve control directs the analysis fluid from the combustion reactor through the adsorption device and on to the detector. In a second operating state, the valve control passes, for example, a flushing fluid through the adsorption device and on to an outlet for the flushing fluid. Preferably, the flushing fluid is not directed through the detector. In a third operating state, for example, the inlet and outlet of the adsorption device are closed so that fluid communication between the adsorption device and the remaining functional units of the elemental analyzer is disconnected.

In one embodiment, the flushing fluid can also be passed through the detector or through a separate detector for the detection of CO₂ or carbon. In this way, it is possible to determine the amount of bound CO₂ or carbon and thus draw conclusions about the carbon content in the analysis fluid and the sample.

In one embodiment, the elemental analyzer comprises at least two adsorption devices and the valve control is configured to pass the analysis fluid in parallel over two or more adsorption devices. In this way, it is possible to multiply the adsorption capacity.

In a further embodiment, the valve control is configured in such a way that the analysis fluid of similar samples is always passed over the same adsorption device when several adsorption devices are present. In this way, it is possible to minimize or completely eliminate systematic measurement errors that can occur due to individual differences between the adsorption devices. Preferably, for this purpose, the valve control comprises an electronic memory unit for storing identification data of samples and adsorption devices. Thus, it is possible to assign samples to a specific adsorption device based on their identification data.

Preferably, the elemental analyzer comprises a control unit for controlling the valve control and the heating device of the adsorbent device. Preferably, the control unit also controls the cooling device, if present, for cooling the adsorbing material of the adsorption device. In this way, the valve control is coupled to the heating device so that the heating device is preferably only activated when no analysis fluid is passed through the adsorption device. In addition, the valve control is preferably coupled to the cooling device, if any, for cooling the adsorbent material, so that the cooling device is preferably activated only after the flushing fluid has been passed through the adsorption device.

The elemental analyzer comprises a detector for detecting at least one constituent of the analysis fluid. Preferably, it is a detector for detecting gaseous components of the analysis fluid. Particularly preferably, it is a detector for detecting elemental nitrogen and/or carbon in the analysis fluid. In one embodiment, the detector is a thermal conductivity detector. Preferably, the detector comprises a chromatography device for separating the remaining components of the analysis fluid. Particularly preferably, this is a gas chromatography device.

Method for Removing CO₂ from a Fluid Stream

The method of removing CO₂ from a fluid stream according to the disclosure comprises the steps:
Provide an adsorption device described above for adsorbing CO₂;
Passing a fluid stream containing CO₂ through the adsorbent device so that CO₂ is adsorbed from the fluid stream by the adsorbent material;
Stopping the CO₂-containing fluid stream;
Heating the adsorbent material by means of the heating device and passing a flushing fluid stream through the adsorbent device so that adsorbed CO₂ is flushed out of the adsorbent material; and
Stopping the flow of flushing fluid.

The method is suitable for removing CO₂ from any fluid stream. The fluid stream may contain liquid and gaseous components. In addition, the fluid stream may also contain solid particles, for example soot particles, as long as the particle size and amount of solid particles do not lead to an impairment of the adsorbent material. Preferably, the fluid stream is a gas or a gaseous mixture, particularly preferably a gaseous mixture that may contain water vapor. Particularly preferably, the fluid stream comprises only gaseous components.

In one embodiment, the fluid stream is an analysis fluid obtained by combustion of a sample, preferably an organic sample, more preferably a food or feed sample. Preferably, the fluid stream is obtained by the following steps:

Burning a sample in a combustion reactor to obtain an analysis fluid; passing the analysis fluid through a reduction reactor to reduce oxidized components of the analysis fluid; passing the analysis fluid through a water separator to remove water from the analysis fluid.

Preferably, the fluid stream containing CO₂ is passed through the adsorbent device at a temperature of 10° C. to 40° C., preferably a temperature of 15° C. to 30° C., more preferably a temperature of 18° C. to 25° C., such that CO₂ is adsorbed from the fluid stream by the adsorbent material.

After the CO₂-containing fluid stream has been passed through the adsorption device, the adsorbed CO₂ is flushed out of the adsorbent material by heating the adsorbent material by means of the heating device and passing a flushing fluid stream through the adsorption device. Preferably, the adsorbent material is thereby heated to a core temperature between 100° C. and 300° C., preferably 150° C. and 250° C., more preferably 180° C. and 220° C. In a particularly preferred embodiment, the adsorbent material is first heated to the specified core temperature and then the flushing fluid stream is passed through the adsorption device and through the adsorbent material.

The flushing fluid used is preferably a fluid that does not itself contain any components that are adsorbed by the adsorbent material or that react chemically with the adsorbent material. Preferably, the flushing fluid is a noble gas, for example helium or argon. In a preferred embodiment, helium is used as the flushing fluid.

In a preferred embodiment, the adsorbent device comprises a cooling device described above. In this case, the method includes the additional step of cooling the adsorbent material by means of the cooling device after the adsorbed CO₂ has been purged from the adsorbent material. During cooling of the adsorbent material by means of the cooling device, the flushing fluid flow may be shut off or may continue to pass through the adsorbent material.

### BRIEF DESCRIPTION OF THE DRAWINGS

The terms Fig., Figs., Figure, and Figures are used interchangeably in the specification to refer to the corresponding figures in the drawings.

Further features of the disclosure are illustrated with reference to the drawings described below:

FIG. 1 Perspective view of an adsorption device according to a first embodiment.

FIG. 2 Perspective sectional view of an adsorption device according to the first embodiment.

FIG. 3 Side sectional view of an adsorption device according to a second embodiment.

FIG. 4 Perspective sectional view of an adsorption device according to the second embodiment.

### DESCRIPTION

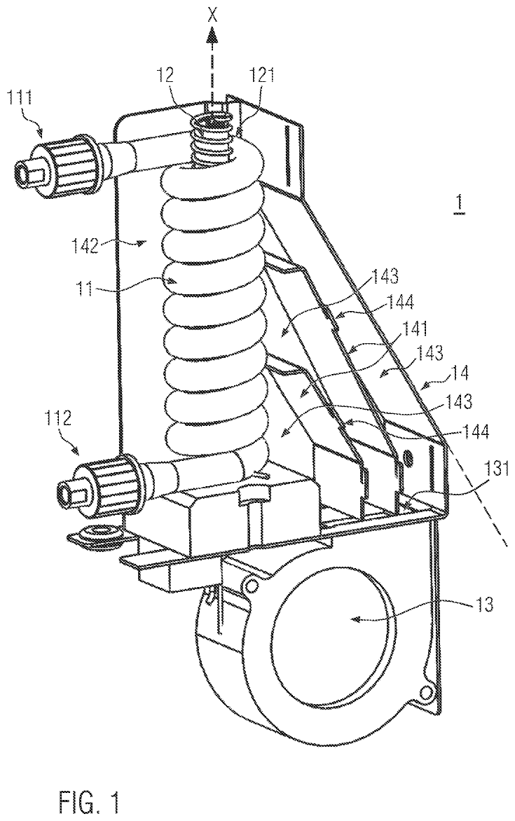

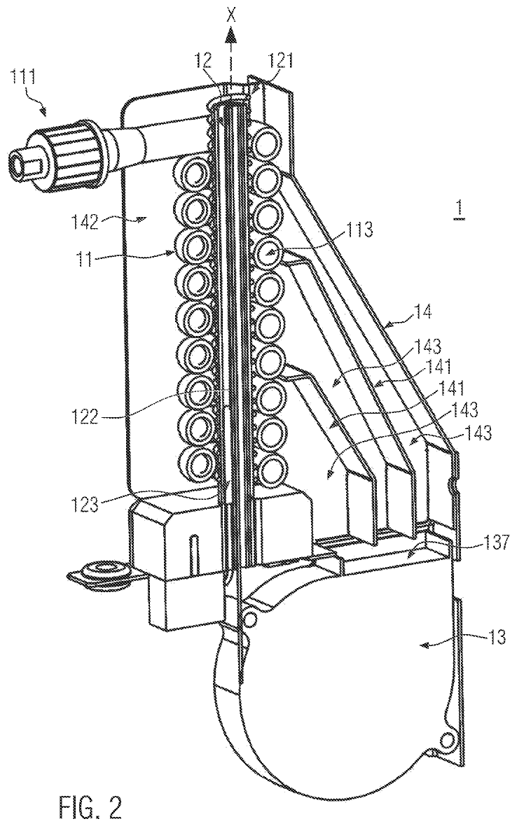

FIGS. 1 and 2 show a first embodiment of an adsorption device 1. The adsorption device 1 comprises a filter 11, a heating device 12 and a cooling device 13.

The filter 11 has the shape of a tube that is spirally wound around the rod-shaped heating device 12. The filter 11 completely surrounds the rod-shaped heating device 12 in the radial direction. At both ends of the tube, the filter 11 has an inlet 111 and an outlet 112.

The adsorbent material, which is not itself shown in the drawings, is disposed in the lumen 113 of the tube.

The heating device 12 extends along a longitudinal axis x. It is a straight, rod-shaped heating device, so that the spiral-shaped filter 11 can be plugged onto the rod-shaped heating device 12 in a simple manner. The heating device 12 is thus accommodated in the axial cavity of the spiral-shaped filter 11.

The heating device 12 comprises a heating wire 121 spirally wound around a rod-shaped base 122. The rod-shaped base 122 consists of a tube, preferably a mica tube, inside which a temperature sensor 123 is arranged. By means of the temperature sensor 123, the temperature of the heating device 12 can be determined and controlled.

The cooling device 13 is arranged below the heating device 12 and the filter 11 in the axial direction with respect to the longitudinal axis x. The cooling device 13 is a fan 13. The fan 13 has an outlet opening 131 by means of which air used for cooling can be discharged in the axial direction with respect to the longitudinal axis x. The fan 13 is arranged below the heating device 12 and the filter 11 in the axial direction.

The adsorption device 1 further comprises a housing 14, in which the heating device 12 and the filter 11 are arranged. The fan 13 is connected to the housing 14 on the outside of the housing 14. The housing 14 does not completely surround the heating device 12 and the filter 11, but is open on the side facing the viewer in FIGS. 1 and 2. On the rear side, the housing 14 has an outer wall 142. Inside the housing, a plurality of lamellar inner walls 141 are formed through which a plurality of flow channels 143 are formed. Through the flow channels 143, the air discharged from the fan 13 is directed to the filter 11 such that the air impinges on the filter 11 in a radial direction with respect to the longitudinal axis x.

Connecting means 144 are formed on each of the inner walls 144. These connecting means 144 can be used to couple the housing 14 to a second adsorption device. For this purpose, the projections 144 can engage in corresponding receptacles in the outer wall 142 of a second adsorption device. In this way, several adsorption devices 1 can be mechanically coupled to each other.

In the embodiment shown, the inlet 111 and the outlet 112 of the filter 11 are each equipped with connection means. By means of these connection means, the inlet 111 and the outlet 112 can each be connected in a fluid-tight manner to a valve device that is not shown.

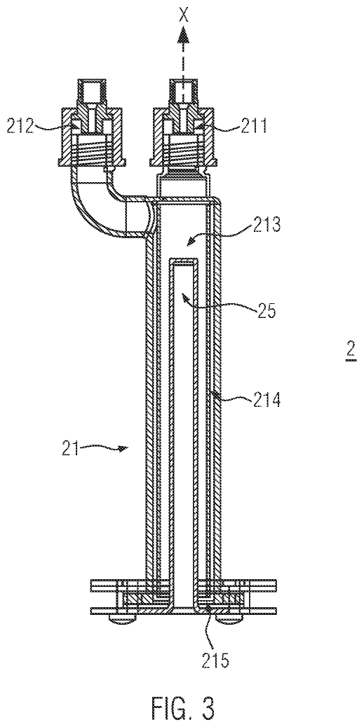

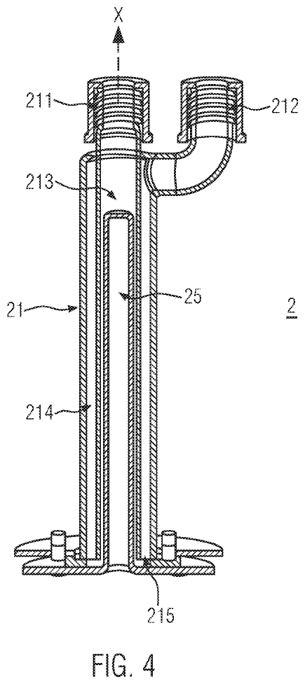

FIGS. 3 and 4 show another adsorption device 2 according to a second embodiment.

The adsorption device 2 has a filter 21 and a rod-shaped heating device not shown individually in FIGS. 3 and 4. The heating device may comprise a rod-shaped base and a heating wire arranged spirally around the rod-shaped base, as depicted in FIGS. 1 and 2.

The filter 21 includes an outer, first chamber 214 and an inner, second chamber 213. The first chamber 214 and the second chamber 213 surround an axial cavity 25 in which the heater can be disposed. The cavity 25 is open at the bottom so that the rod-shaped heating device can be inserted into the cavity 25.

The heating device as well as the filter 21 both extend along a longitudinal axis x. The first chamber 214 and the second chamber 213 are each arranged coaxially with respect to this longitudinal axis x. At the upper end of the filter 21 with respect to the longitudinal axis x, the filter 21 has an inlet 211 and an outlet 212. The inlet 211 forms the upper opening of the inner, second chamber 213. The outlet 212 forms the upper opening of the outer, first chamber 214. The inner, second chamber 213 is fluidically connected to the outer, first chamber 214 at the lower end 215 of the filter via a gap. In this manner, a fluid can be passed through the inlet 211 and the inner, second chamber 213 into the outer, first chamber 214 and ultimately through the outlet 212.

In this embodiment, the adsorbent material may be disposed in either the outer, first chamber 214 and/or the inner, second chamber 213. Preferably, the adsorbent material is disposed in the outer, first chamber 214.

In this embodiment, the inlet 211 and the outlet 212 are each provided with connection means by means of which the inlet 211 and the outlet 212 can each be connected to valves in a fluid-tight manner.

### LIST OF REFERENCE SIGNS

1, 2 Adsorption device
11, 21 Filter
111, 211 Inlet
112, 212 Outlet
113 Lumen
213 Second chamber
214 First chamber
12 Heating device
121 Heating wire
122 Rod shaped base
123 Temperature sensor
13 Cooling device
131 Outlet opening
14 Housing
141 Interior walls
142 Exterior wall
143 Flow channels
144 Connecting means
25 Cavity
x Longitudinal axis

1. An adsorption device for adsorption of CO₂ for an elemental analyzer, the adsorption device comprises
a filter having an inlet for a fluid, an outlet for the fluid, and an adsorbent material through which the fluid can flow, and
a heating device for heating the adsorbent material,
wherein
the heating device extends along a longitudinal axis, and
the filter is arranged coaxially to the longitudinal axis and at least partially radially surrounds the heating device.

2. An adsorption device according to claim 1, wherein the filter is arranged along a longitudinal direction in a spiral around the heating device.

3. An adsorption device according to claim 2, wherein the inlet and the outlet are arranged on opposite sides of the filter with respect to the longitudinal axis.

4. An adsorption device according to claim 1, wherein the filter comprises a first chamber, the adsorbent material being arranged in the first chamber, the first chamber surrounding a cavity extending along the longitudinal axis, and the heating device being arranged in the cavity.

5. An adsorption device according to claim 4, wherein the filter further comprises a second chamber fluidically connected to the first chamber, surrounding the cavity and arranged between the first chamber and the cavity, wherein the adsorbent material is arranged in the first chamber and/or the second chamber.

6. An adsorption device according to claim 1, wherein the adsorption device further comprises a cooling device for cooling the adsorbing material.

7. An adsorption device according to claim 6, wherein the cooling device formed by a fan.

8. An adsorption device according to claim 1, wherein the heating device formed by an electric heating wire arranged spirally around a rod-shaped base.

9. An adsorption device according to claim 8, wherein the rod-shaped base comprises a temperature sensor.

10. An adsorption device according to claim 1, wherein the adsorption device comprises a first valve which is connected to the inlet and by means of which a first and a second fluid can be alternately directed into the filter.

11. An elemental analyzer comprising a combustion reactor for burning a sample, an optional reduction reactor, an optional water separator, and a detector,
wherein
the elemental analyzer comprises an adsorption device for adsorbing CO₂ according to claim 1,
and the elemental analyzer comprises a valve control for alternately passing an analysis fluid from the combustion reactor through the adsorption device for adsorption of CO₂ and to the detector or a flushing fluid through the adsorption device for adsorption of CO₂.

12. The elemental analyzer according to claim 11, wherein the flushing fluid can also be passed through the detector or through a separate detector for detecting CO₂ or carbon in the flushing fluid.

13. The elemental analyzer according to claim 11, wherein the elemental analyzer comprises at least two adsorption devices for adsorption of CO₂ and the valve control is configured such that the analysis fluid can be passed in parallel over two or more adsorption devices.

14. The elemental analyzer according to claim 11, wherein the elemental analyzer comprises at least two adsorption devices for adsorption of CO₂ and the valve control is configured such that the analysis fluid of similar samples can be passed over the same adsorption devices.

15. A method for removing CO₂ from a fluid stream, comprising the steps of:
providing an adsorption device for adsorbing CO₂ according to claim 1;
passing a fluid stream containing CO₂ through the adsorbent device so that CO₂ is adsorbed from the fluid stream by the adsorbent material;
stopping the CO₂-containing fluid stream;
heating the adsorbent material by means of the heating device and passing a flushing fluid stream through the adsorption device so that adsorbed CO₂ is flushed out of the adsorbent material again; and
stopping the flow of flushing fluid.

16. The adsorption device according to claim 1, wherein the filter forms a receptacle extending along the longitudinal axis, wherein the heating device extends along a straight longitudinal axis and is configured to be removable insertable into the receptacle.
